(19) United States
(12) Patent Application Publication
(10) Pub. No.: US 2010/0328812 A1
(43) Pub. Date: Dec. 30, 2010

(54) MAGNETIC DISK DEVICE

(75) Inventors: Masamitsu OHHASHI, Tachikawa-shi (JP); Michihiko UMEDA, Kawasaki-shi (JP)

Correspondence Address: KNOBBE MARTENS OLSON & BEAR LLP, 2040 MAIN STREET, FOURTEENTH FLOOR, IRVINE, CA, 92614, US

(73) Assignee: Toshiba Storage Device Corporation, Tokyo (JP)

(21) Appl. No.: 12/823,052

(22) Filed: Jun. 24, 2010

(30) Foreign Application Priority Data
Jun. 29, 2009 (JP) 2009-154376

(51) Int. Cl. G11B 5/596

(52) U.S. Cl. 360/77.03; G9B/5.216

(57) ABSTRACT

According to one embodiment, a magnetic disk device includes a receiver, a storage module, a determining module, and a prescanner. The receiver receives a command from a host device. The storage module stores, with respect to each of divided areas formed by dividing the recording area of a recording medium into a plurality of areas, pre-scan control information indicating at least one of the receiving time and the number of receiving times. The receiving time indicates a time at which a write command is received. The number of receiving times indicates the number of times the write command is received within a predetermined period after the power is turned on. The determining module determines the order in which pre-scan is performed on the divided areas based on at least one of the receiving time and the number of receiving times. The prescanner pre-scans the divided areas in the determined order.

### CROSS-REFERENCE TO RELATED APPLICATIONS

This application is based upon and claims the benefit of priority from Japanese Patent Application No. 2009-154376, filed on Jun. 29, 2009, the entire contents of which are incorporated herein by reference.

### BACKGROUND

1. Field

Embodiments described herein relate generally to a magnetic disk device.

2. Description of the Related Art

As the recording density of recording media such as magnetic disks increases, a magnetic disk device generally scans a magnetic disk to detect flaws on the magnetic disk or a bad sector of the magnetic disk at an early stage to recover the magnetic disk (see, for example, Japanese Patent Application Publication (KOKAI) Nos. 2007-242207 and H4-310671). Specifically, while a magnetic disk device reads a recording area of a magnetic disk, when a sector in which an unrecoverable read error occurs is detected, the magnetic disk device records it as log data. When a sector in which a recoverable read error occurs is detected, the magnetic disk device rewrites data or recovers the bad sector by an alternate process. Among such functions of performing a scan is a pre-scan function. An application that realizes the pre-scan function is launched immediately after the magnetic disk device is turned on while the magnetic disk device receives no command from a host device as an upper device and is idle. After the launch, the magnetic disk device performs a scan all over the recording area of the magnetic disk by unit of read launching (for example, by one track). When the magnetic disk device receives a command instructing to write data to a recording area where a scan is not yet performed (hereinafter, “unscanned area”) from the host device while performing such a scan, the magnetic disk device performs a verify process to verify whether data is correctly written after writing the data according to the command to detect defects on a sector to be written at an early stage. Such a function increases the reliability of the magnetic disk.

As described above, the pre-scan function increases the reliability of the magnetic disk. On the other hand, when writing is performed on the unscanned area, the verify process intervenes. This verify process requires extra waiting time, generally one rotational delay. Because of this, a response that indicates the termination of the command to the host device is delayed.

With a conventional pre-scan function, scan is performed sequentially from a logical block at the head of a magnetic disk without consideration of the condition or order in which scan is performed. As a result, when the logical block does not match the pattern of the command from the host device, the verify process is performed every time writing is performed on the unscanned area. This may increase the delay of the response to the host device. Although the verify process after data writing is performed on only a recording area to be written, and a scan is performed on a sector from which reading is instructed by a command from the host device that instructs data reading, a recording area of the sector is not treated as a pre-scanned recording area, and the verify process is performed on the recording area. Accordingly, the pre-scan becomes extremely inefficient.

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary block diagram of a hard disk drive (HDD) as a magnetic disk device according to an embodiment;

FIG. 2 is an exemplary diagram of a data structure of pre-scan control information stored in a pre-scan table in the embodiment;

FIG. 3 is an exemplary diagram of a data structure of an order management table in the embodiment;

FIG. 4 is an exemplary flowchart of an order determination process by which the order of pre-scan is determined in the embodiment;

FIG. 5 is an exemplary flowchart of a pre-scan process performed by the HDD illustrated in FIG. 1 in the embodiment;

FIG. 6 is an exemplary flowchart of a process when the HDD illustrated in FIG. 1 receives a write command while performing a pre-scan in the embodiment;

FIGS. 7A to 7C are exemplary diagrams for comparing an area to be subjected to a verify process when a write command is received for a write area that is an unscanned area in a conventional technology with that in the embodiment.

FIG. 8 is an exemplary flowchart of a process when a read command is received in the embodiment; and

FIGS. 9A to 9C are exemplary diagrams for comparing an area to be subjected to a verify process when a read command is received for an access area that is an unscanned area in a conventional technology with that in the embodiment.

### DETAILED DESCRIPTION

Various embodiments according to the invention will be described hereinafter with reference to the accompanying drawings. In general, according to one embodiment of the invention, a magnetic disk device comprises a receiver, a storage module, a determining module, and a prescanner. The receiver is configured to receive a command transmitted from a host device. The storage module is configured to store, with respect to each of divided areas formed by dividing the recording area of a recording medium into a plurality of areas, pre-scan control information that indicates at least one of the receiving time and the number of receiving times. The receiving time indicates a time at which a write command instructing to write data to all or part of the divided area is received. The number of receiving times indicates the number of times the write command is received within a predetermined period after the power is turned on. The determining module is configured to determine the order in which pre-scan is performed on the divided areas based on at least one of the receiving time and the number of receiving times referring to the pre-scan control information. The prescanner is configured to pre-scan the divided areas in the order determined by the determining module immediately after the power is turned on.

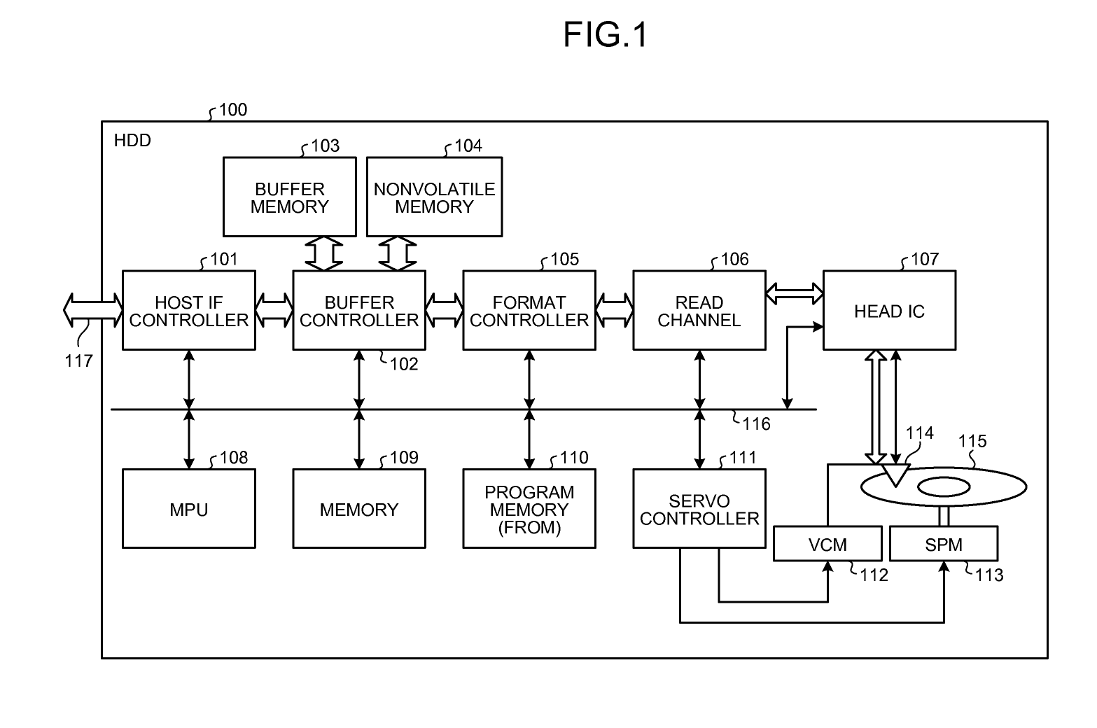

FIG. 1 is a block diagram of a hard disk drive (HDD) 100 as a magnetic disk device according to an embodiment. The HDD 100 comprises a host interface (IF) controller 101, a buffer controller 102, a buffer memory 103, a nonvolatile memory 104, a format controller 105, a read channel 106, a head integrate circuit (IC) 107, a microprocessing unit (MPU) 108, a memory 109, a program memory (FROM) 110, a servo controller 111, a common bus 116 that connects these modules, a voice coil motor (VCM) 112, a spindle motor (SPM) 113 that rotates a disk, a magnetic head 114, and a magnetic disk 115.

The host IF controller 101 communicates with a host device (not illustrated) through an interface bus 117, and receives a command issued by the host device. According to the command, the host IF controller 101 receives data (write data) instructed to be written to the magnetic disk 115 from the host device, or transmits data (read data) instructed to be read and transmitted from the magnetic disk 115 to the host device. In the embodiment, a command instructs to write data to the magnetic disk 115, to read and transmit data from the magnetic disk 115, or to perform a verify process. The execution of the command causes access to the magnetic disk 115. A command that instructs to write data is herein referred to as a write command, a command that instructs to read and transmit data is referred to as a read command, and a command that instructs to perform a verify process is referred to as a verify command. An area to be written (hereinafter, “write area”) is designated by the write command, an area to be read is designated by the read command, and an area to be subjected to a verify process is designated by the verify command. Data reading is performed in the verify process, and therefore, in the embodiment, the verify command is also treated as a command that instructs to read data as with the read command. However, the read command instructs to transmit the read data, while the verify command does not. The read command and the verify command may be referred to as “read type command”. For convenience of description, an area designated by the read type command may be referred to as “access area”.

The FROM 110 is a nonvolatile memory that stores various data or various computer programs to be executed by a central processing unit (CPU). The memory 109 temporarily stores various data such as work variables, and various computer programs. The MPU 108 is a processor functioning as amain controller that loads various computer programs from a read-only memory (ROM) into a random-access memory (RAM) to execute them, and controls the overall operation of the HDD 100. The MPU 108 has a clock (not illustrated) that count the time, and times a receiving time at which a command is received from the host device through the host IF controller 101. The servo controller 111 controls the VCM 112 and the SPM 113 under the control of the MPU 108. The SPM 113 rotates the magnetic disk 115 steadily under the control of the servo controller 111. The VCM 112 moves the magnetic head 114 to the target position under the control of the servo controller 111.

The buffer controller 102 controls memories in the buffer memory 103 and the nonvolatile memory 104, both of which are connected as subordinates of the buffer controller 102. The buffer memory 103 temporarily stores a command received from the host device, write data transmitted from the host device, and read data to be transmitted to the host device, under the control of the buffer controller 102. The nonvolatile memory 104 stores various data under the control of the buffer controller 102.

The format controller 105 functions as a control signal generating circuit that generates signals necessary for the control inside the HDD 100. The head IC 107 amplifies a signal (an analog read signal) read by the magnetic head 114 to output the signal to the read channel 106. The head IC 107 controls the magnetic head 114 to write a signal for writing output from the read channel 106 to the magnetic disk 115. The magnetic head 114 generates a magnetic field to magnetize a magnetic body to write the signal for writing to the magnetic disk 115, or to read data written to the magnetic disk 115 as a signal by detecting changes in the magnetic field. The read channel 106 performs analog/digital (A/D) conversion on a read signal amplified by the head IC 107 to encode the signal, and outputs it to a hard disk controller (HDC). Further, the read channel 106 pulses a read signal to output it to the format controller 105. The read channel 106 also converts data encoded according to each control signal from the format controller 105 into a write signal to output the signal to the head IC 107.

Data reading and data writing with respect to the magnetic disk 115 are performed along tracks arranged concentrically on the magnetic disk 115. A plurality of servo areas are radially formed, to be positioned on each track, on the magnetic disk 115 to pass through each concentric circle. The magnetic head 114 is moved to be positioned at a target track while reading information from the servo areas under the control of the servo controller 111 (on-track). According to the embodiment, a recording area on the magnetic disk 115 is divided into a plurality of areas (divided areas). The HDD 100 is provided with a pre-scan table that stores control information related to pre-scan (pre-scan control information) for each divided area. The pre-scan table is stored in a recording area of at least one of the nonvolatile memory 104 and the magnetic disk 115. Part of the pre-scan control information stored in the pre-scan table is updated on a regular basis.

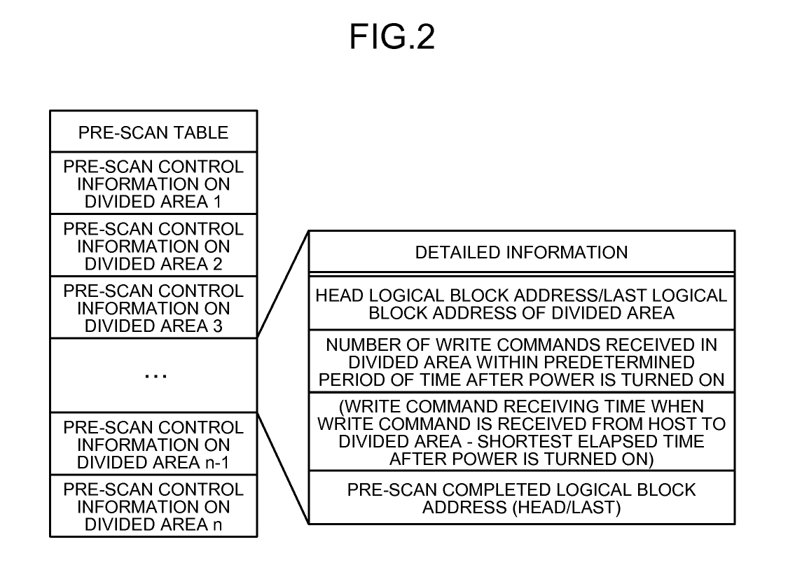

FIG. 2 illustrates an example of a data structure of pre-scan control information stored in a pre-scan table. As illustrated in FIG. 2, the pre-scan control information comprises, for each divided area, a head logical block address, a last logical block address, a write command receiving time, the number of received write commands, and a pre-scan completed logical block address. The head logical block address refers to the address of a logical block at the head of a target divided area. The last logical block address refers to the address of a logical block at the last of a target divided area. The write command receiving time refers to the time at which a first write command is received for a write area that belongs to a target divided area after the power is turned on. The number of received write commands refers to the number of times a write command is received for a write area that belongs to a target divided area within a predetermined period of time after the power is turned on. The pre-scan completed logical block address refers to the address of the head or last logical block in which a pre-scan is completed in the target divided area.

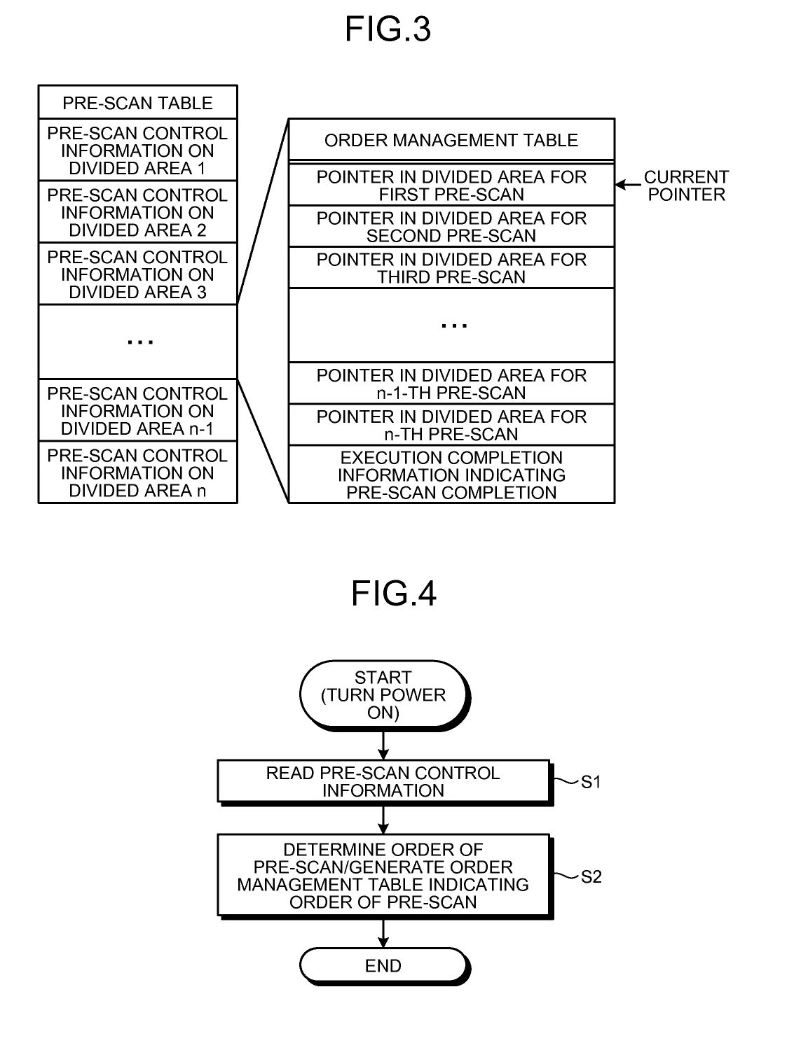

The MPU 108 reads such a pre-scan table immediately after the power is turned on, and determines the order of pre-scan to perform the pre-scan on the divided areas in the order of the write command receiving time, and generates an order management table that indicates the determined order. The order management table is stored in the recording area of at least one of the nonvolatile memory 104 and the magnetic disk 115. FIG. 3 illustrates an example of a data structure of an order management table. In FIG. 3, pointers of the divided areas are indicated in the order in which pre-scan is performed with respect to the pre-scan control information stored in the pre-scan table illustrated in FIG. 2. A current pointer is associated with a divided area to be subjected to pre-scan. When the pre-scan has been performed on all the recording areas, i.e., all the divided areas, in the magnetic disk 115, the pre-scan completion information indicating it is stored in the order management table. The pointers may indicate the head logical block address of each divided area, or an area identification (ID), if assigned, that identifies each of the divided areas.

The MPU 108 performs the pre-scan on each divided area immediately after the power is turned on according to the order indicated by the order management table. When the pre-scan on the target divided area is completed, the MPU 108 updates a pre-scan completed logical block address in the pre-scan control information for the divided area stored in the pre-scan table. When the MPU 108 receives a command from the host device through the host IF controller 101 while performing the pre-scan, the MPU 108 immediately aborts the pre-scan being performed and starts a process according to the command. In this case, the MPU 108 updates the pre-scan completed logical block address in the pre-scan control information stored in the pre-scan table with the logical block address in which the pre-scan is normally completed in the divided area on which the pre-scan is being performed.

At this time, when the command received is a write command, the MPU 108 controls data to be written to the write area designated by the write command, and then judges which of the divided areas corresponds to the write area. The MPU 108 refers to the scan completed logical block address in the pre-scan control information on the judged divided area stored in the pre-scan table. When an area where the pre-scan is not yet performed (an unscanned area) remains, the MPU 108 performs a verify process on, besides the unscanned area, at least one of a logical block preceding the write area and the following logical block. In the verify process, the MPU 108 reads data from these areas and verifies whether the data is normally written. The MPU 108 updates the logical block address of the divided area where the verify process is normally completed as a pre-scan completed logical block address in the pre-scan control information stored in the pre-scan table. The MPU 108 increments the number of received write commands in the pre-scan control information stored for the divided area in the pre-scan table by one to update it. When the received write command is a command received first for the divided area to which the write area belongs after the power is turned on, the MPU 108 updates a write command receiving time in the pre-scan control information for the divided area stored in the pre-scan table with the receiving time of the write command.

When the command received from the host device is a read command or a verify command, the MPU 108 judges to which of the divided areas an access area designated by the command belongs, and refers to a pre-scan completed logical block address in the pre-scan control information on the judged divided area stored in the pre-scan table. When an unscanned area where the pre-scan is not yet performed for the divided area remains, data is read from, as an area to be read, besides the access area, a logical block preceding the access area and the following logical block. The MPU 108 updates the pre-scan completed logical block address in the pre-scan control information stored in the pre-scan table with the logical block address of the divided area where data reading is normally completed. In other words, for the divided areas corresponding to the logical block preceding the access area and the following logical block, a verify process is assumed to be performed by reading data. In the embodiment, the divided area is treated as an area where a pre-scan is completed, and thus an unnecessary verify process on the divided area is avoided.

Typically, the MPU 108 reads data from the magnetic disk 115 including the logical block following the access area designated by a read command, and stores the data as cache data in the buffer memory 103 and the nonvolatile memory 104. In such a manner, when the MPU 108 pre-reads the logical block following the designated access area, the pre-scan completed logical block address in the pre-scan control information on the divided area to which an area where reading can be normally performed at the completion of the pre-reading belongs, stored in the pre-scan table is updated as needed. Because of this, an unnecessary verify process can be efficiently avoided by utilizing a pre-reading function. When the pre-scan has been performed on all recording areas, i.e., all divided areas, on the magnetic disk 115, the MPU 108 stores the pre-scan completion information indicating it in the order management table.

The operation of the HDD 100 of the embodiment will be described. An order determination process to determine the order in which pre-scan is performed will be described referring to FIG. 4. When the HDD 100 is tuned on, the MPU 108 reads pre-scan control information from a pre-scan table (S1), and then determines the order of pre-scan to perform the pre-scan on the divided areas in the order of the write command receiving time in the pre-scan control information. Subsequently, the MPU 108 generates an order management table that indicates the determined order (S2). In this process, the MPU 108 associates a current pointer with a pointer of a first divided area in the order.

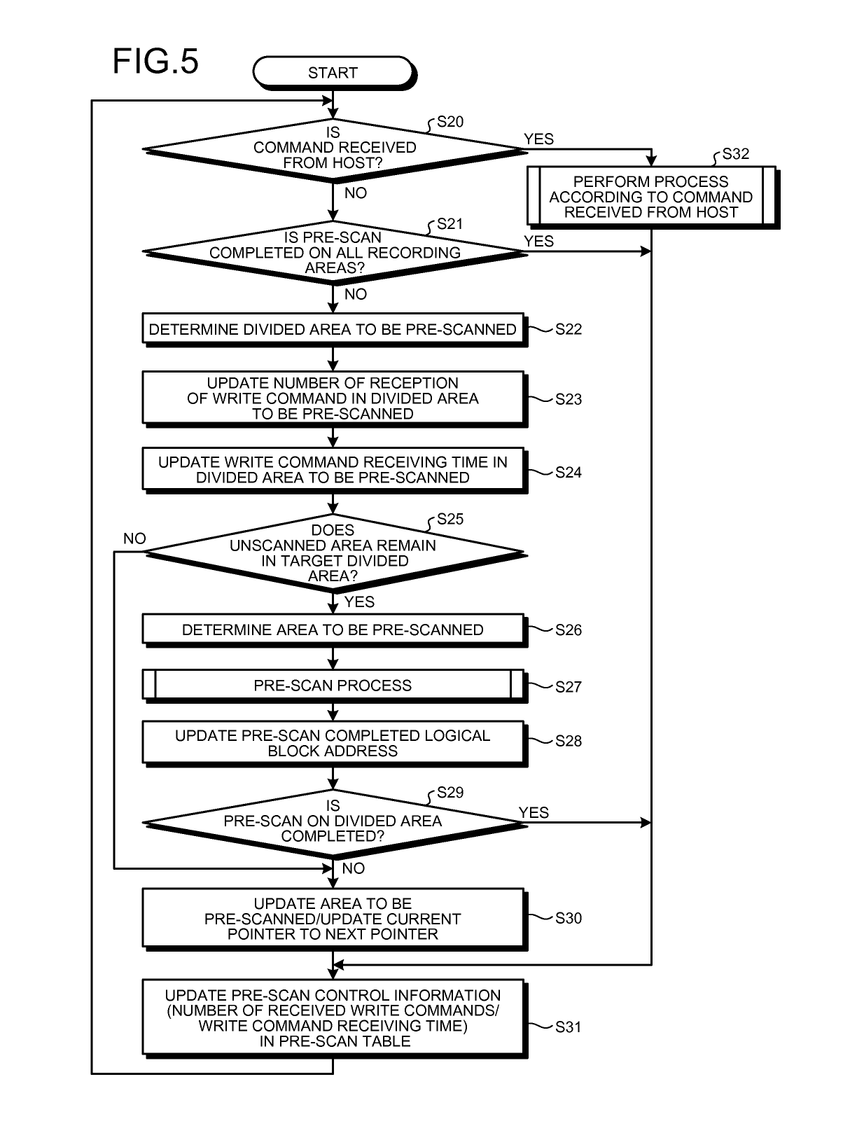

A pre-scan process performed by the HDD 100 will be described referring to FIG. 5. The MPU 108 of the HDD 100 judges whether a command is received from the host device (S20). If a command is not received (No at S20), the MPU 108 refers to a pre-scan table to judge whether pre-scan is completed on all recording areas on the magnetic disk 115 (S21). If pre-scan is not completed (No at S21), the MPU 108 determines a divided area to be pre-scanned (S22). In this process, the MPU 108 determines a divided area associated with a current pointer in the order management table as an area to be pre-scanned. With respect to a write command designating as a write area an area belonging to the divided area determined as an area to be pre-scanned at S22, when the number of received write commands and the write command receiving time are not updated due to the occurrence of some error, the MPU 108 increments the number of received write commands in the pre-scan control information on the divided area stored in the pre-scan table by one to update it (S23). When the write command is a command received first for the divided area after the power is turned on, the MPU 108 updates the write command receiving time in the pre-scan control information on the divided area stored in the pre-scan table with the receiving time of the write command (S24).

The MPU 108 refers to a pre-scan completed logical block address in the pre-scan control information on the divided area determined at S22 stored in the pre-scan table, and judges whether an unscanned area where the pre-scan is not yet performed remains in the divided areas (S25). If an unscanned area remains (Yes at S25), the MPU 108 determines the unscanned area as a target for the pre-scan (S26), and performs the pre-scan on the unscanned area (S27). The MPU 108 updates the pre-scan completed logical block address in the pre-scan control information on the divided area stored in the pre-scan table with the address of the logical block in which the pre-scan is completed (S28). The MPU 108 judges whether the pre-scan is completed on all the divided areas (S29). If not (No at S29), the process moves to S30. If an unscanned area does not remain (No at S25), the process also moves to S30. The MPU 108 associates the current pointer with the pointer of a divided area next to the divided area determined at S22 in the order management table (S30), and the process moves to S31. If the judgment results at S21 and S29 are positive, the MPU 108 stores the pre-scan completion information indicating that the pre-scan is completed on all the divided areas in the order management table, and the process moves to S31.

On the other hand, if a command is received at S20, the MPU 108 performs a process according to the command received from the host device (S32), and then the process moves to S31. At S31, when the command received at S20 is a write command, the MPU 108 increments the number of received write commands in the pre-scan control information on the divided area, to which a write area designated by the write command belongs, stored in the pre-scan table by one to update it. Moreover, when the write command is a command received first for the divided area after the power is turned on, the MPU 108 updates the write command receiving time in the pre-scan control information on the divided area stored in the pre-scan table with the receiving time of the write command. Subsequently, the MPU 108 transmits a response message indicating that data writing by the write command is completed to the host device.

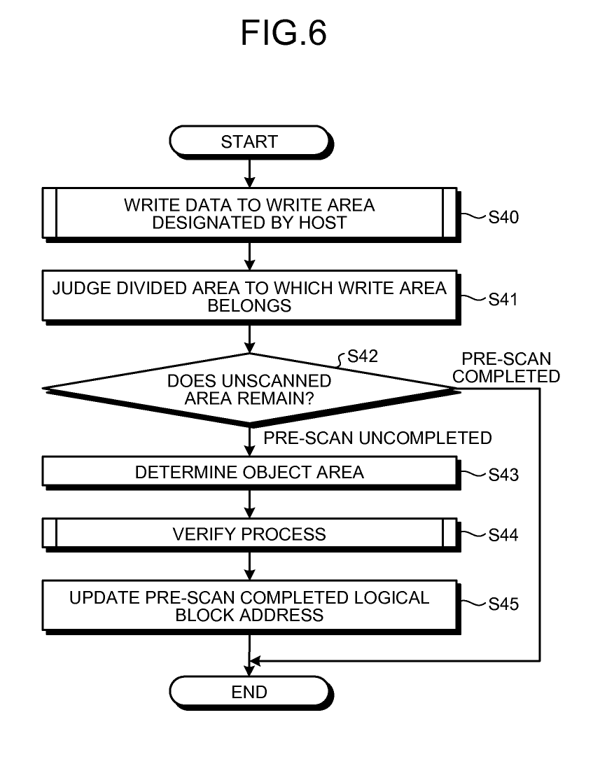

A process when the HDD 100 receives a write command while performing a pre-scan will be described referring to FIG. 6. The MPU 108 of the HDD 100 controls data to be written to the write area designated by the write command (S40). As a result, a write signal that is the data encoded by the HDC 110 and is converted by the read channel 106 is written to the magnetic disk 115 by the magnetic head 114. Moreover, the MPU 108 judges to which of the divided areas the write area belongs (S41). Subsequently, the MPU 108 refers to a scan completed logical block address in the pre-scan control information on the divided area judged at S41 stored in the pre-scan table, and judges whether an area where the pre-scan is not yet performed (an unscanned area) remains. If an unscanned area remains (pre-scan uncompleted at S42), the MPU 108 determines, besides the unscanned area, at least one of a logical block preceding the write area and the following logical block, as an area to be subjected to a verify process (S43), and performs the verify process on the area (S44).

The MPU 108 updates the pre-scan completed logical block address in the pre-scan control information stored in the pre-scan table with the address of the logical block in which the pre-scan is normally completed in the divided area on which the verify process is completed (S45). Moreover, the MPU 108 increments the number of received write commands in the pre-scan control information on the divided area stored in the pre-scan table by one to update it. When the received write command is a write command received first for the divided area after the power is turned on, the MPU 108 updates the write command receiving time in the pre-scan control information on the divided area stored in the pre-scan table with the receiving time of the write command. As a result of the judgment at S42, if no unscanned area remains (pre-scan completed at S42), the process ends.

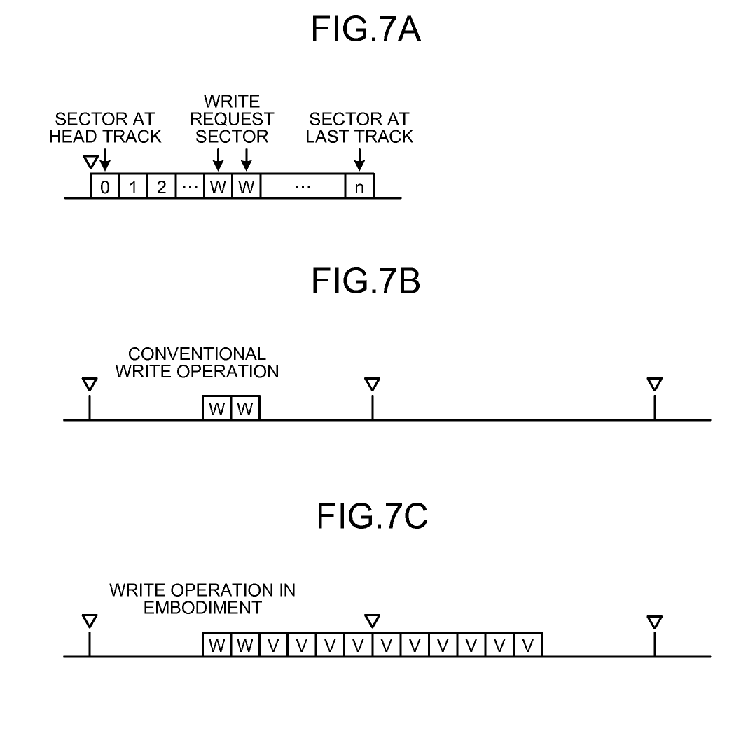

FIGS. 7A to 7C are diagrams for comparing a conventional technology with the embodiment as to an area to be subjected to a verify process when a write command is received for a write area that is an unscanned area. The write area designated by the write command corresponds to a write request sector illustrated in FIG. 7A. In the conventional technology, as illustrated in FIG. 7B, data is written to the write area by the write command, and thereafter, a verify process is performed on the write area. On the other hand, according to the embodiment, for example, as illustrated in FIG. 7C, data is written to the write area by the write command, and thereafter, the verify process is performed on not only the write area but also the logical block following the write area. To the logical block following the write area, writing is likely to be instructed by another write command. Accordingly, at the time when the write command is received, the verify process is performed in advance on not only the write area to which the write command instructs writing, but also the area to which writing is likely to be instructed next. Thus, when another write command is received, the verify process does not need to be performed on the area. As a result, the processing time can be shortened, and the delay of a response to the host device can be suppressed.

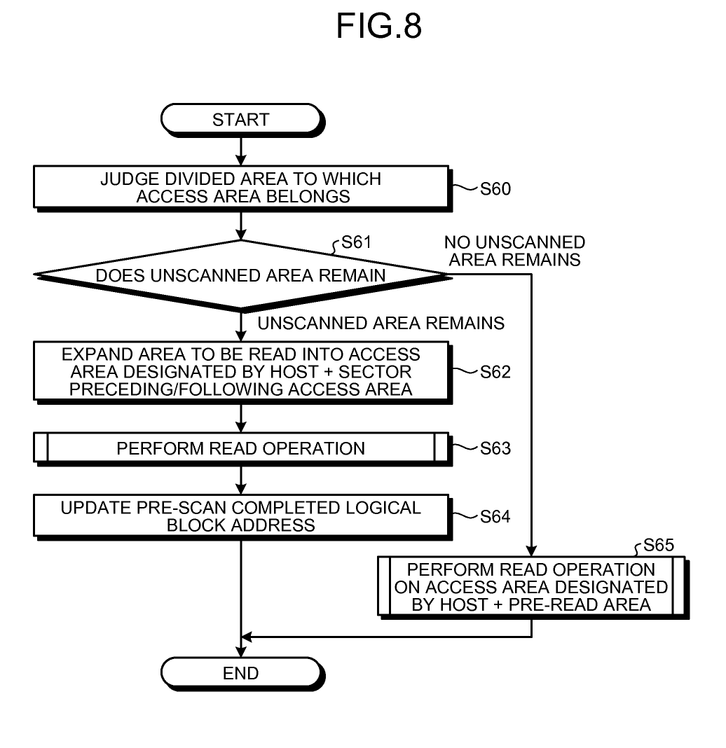

A process when the HDD 100 receives a read command or a verify command during pre-scan will be described in detail. The process when a read command is received is described referring to FIG. 8. The MPU 108 judges to which of the divided areas an access area designated by the read command received belongs (S60). The MPU 108 refers to a scan completed logical block address in the pre-scan control information on the divided area judged at S60 stored in the pre-scan table, and judges whether an unscanned area where the pre-scan is not yet performed on the divided area remains (S61). If the unscanned area remains, the MPU 108 designates, in addition to the access area designated by the read command, a logical block preceding the access area and the following logical block, as an area to be read, thereby expanding the area to be read (S62) to control data reading (S63). As a result, the data in the area to be read is read as a signal by the magnetic head 114, amplified by the head IC 107, and A/D converted by the read channel 106 to be encoded. In this process, the MPU 108 stores data read from the logical block following the access area (pre-read area) in the buffer memory 103 or the nonvolatile memory 104 as cache data. The MPU 108 updates the pre-scan completed logical block address in the pre-scan control information stored in the pre-scan table with the logical block address of the divided area where data reading is normally completed, i.e., the divided area where the verify process is normally completed (S64).

On the other hand, as a result of the judgment at S61, if no unscanned area remains, the MPU 108 designates, in addition to the access area designated by the read command, a logical block following the access area (pre-read area), as an area to be read to control data reading (S65). In this process, the MPU 108 stores data read from pre-read area in the buffer memory 103 or the nonvolatile memory 104 as cache data. After S64 or S65, when data reading by the read command is completed, the MPU 108 transmits a response message including data read from the access area to the host device. In the process when the HDD 100 receives a verify command, the operation to read data is basically the same as that when a read command is received, and thus the description is not repeated. In the case of the verify command, the HDD 100 does not transmit the read data.

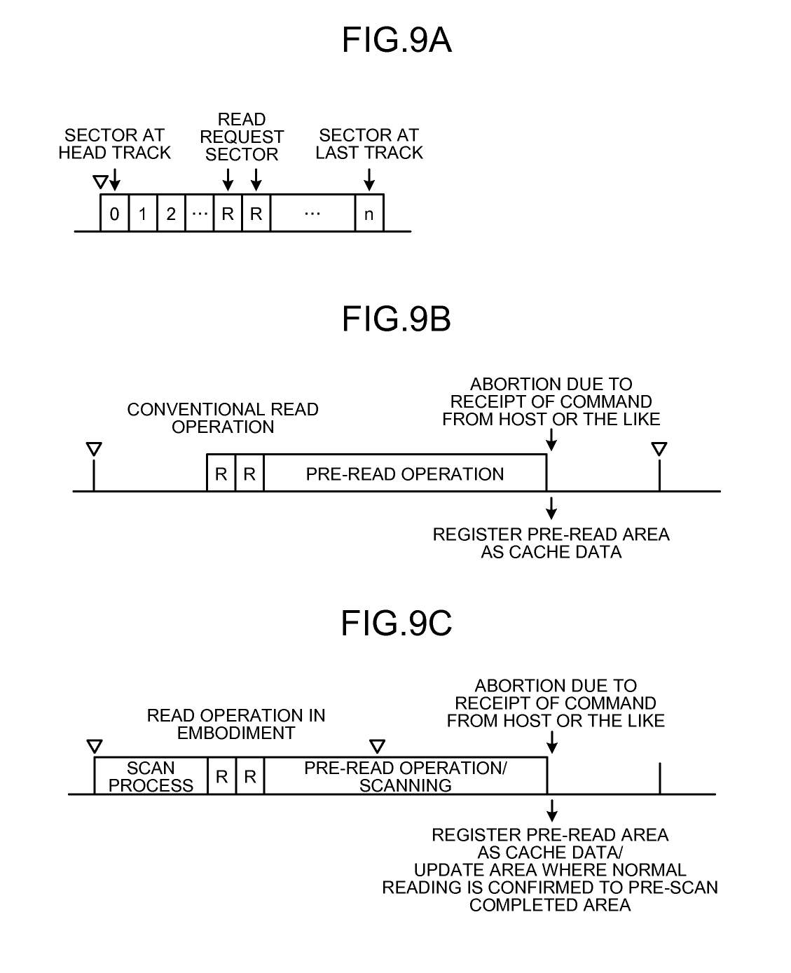

FIGS. 9A to 9C are diagrams for comparing a conventional technology with the embodiment as to an area to be subjected to a verify process when a read command is received for an access area that is an unscanned area. The access area designated by the read command corresponds to a read reqiest sector illustrated in FIG. 9A. In the conventional technology, as illustrated in FIG. 9B, in addition to the read area designated by the read command, a logical block following the read area is designated as an area to be read, and data is read from the area to be read. The data read from the pre-read area is stored as cache data. When a command is received from the host device, the pre-read of data is aborted. According to the embodiment, as illustrated in FIG. 9C, in addition to the read area designated by the read command, a block preceding the access area and a logical block following the access area are designated as an area to be read, and data is read from these areas to be read. As described above, when the access area is an unscanned area, a verify process can be determined to be performed by performing data reading also on the logical block preceding the access area, and the area can be treated as an area where the pr-scan is completed. Regarding the pre-read area pre-read as with the conventional process, the data read from the area is stored as cache data. Although the pre-read of data is aborted when a command is received from the host device, in the embodiment, the divided area where data reading is normally completed is treated as a divided area where the verify process is normally completed. In other words, when data can be normally read also from the pre-read area, the verify process is not needed to be performed again, and thus the area can be treated as an area where the pre-scan is completed. Therefore, a process time can be shortened by avoiding an unnecessary verify process, and the delay of a response to the host device can be suppressed.

As described above, an area to be accessed can be predicted effectively by dividing the recording area of the magnetic disk 115 into a plurality of divided areas, and by determining the order in which pre-scan is performed for the divided areas so that pre-scan is performed in the order of time when a write command is received from the host device. Thus, the pre-scan can be performed prior to writing by the write command. As a result, the delay of a response for the write command to the host device can be suppressed.

When an unscanned area remains in the write area designated by the write command, at least one of the logical blocks before and after the unscanned area is predicted to be accessed. For this reason, a verify process is performed on, besides the unscanned area, at least one of the logical blocks before and after the unscanned area, and thus the verify process can be performed efficiently.

Moreover, when an unscanned area remains in the access area where reading is instructed by a read command or a verify command, data is read from the logical blocks before and after the unscanned area. The area where the reading is normally completed is treated as an area where a verify process is normally completed, and thus an unnecessary verify process can be avoided.

In the embodiment described above, various computer programs executed by the HDD 100 may be stored in a computer connected via a network such as the Internet and downloaded therefrom through the network. The computer programs may also be provided as being stored in a computer-readable recording medium, such as a compact disk read only memory (CD-ROM), a flexible disk (FD), a compact disc-recordable (CD-R), and a digital versatile disc (DVD), as files in an installable or executable format.

In the embodiment described above, the MPU 108 of the HDD 100 may determine the order of pre-scan to perform the pre-scan in the descending order of the number of write commands received from the host device within a predetermined period of time after the power is turned on.

The various modules of the systems described herein can be implemented as software applications, hardware and/or software modules, or components on one or more computers, such as servers. While the various modules are illustrated separately, they may share some or all of the same underlying logic or code.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A magnetic disk device comprising:
a receiver configured to receive a command from a host device;
a storage module comprising a recoding medium comprising a recording area comprising one or more areas, configured to store pre-scan control information that indicates one or more receiving times, each receiving time indicating a time when a write command instructing to write data to the one or more areas is received, and the number of receiving times indicating number of times the write command is received within a predetermined period after power is turned on, with respect to the one or more areas;
a determining module configured to determine an order of pre-scanning on the one or more areas based on one or more the receiving times and the number of receiving times referring to the pre-scan control information; and
a prescanner configured to pre-scan the one or more areas in the order determined by the determining module immediately after the power is turned on.

2. The magnetic disk device of claim 1, further comprising an updating module configured to update the receiving time in the pre-scan control information for the one or more areas with a time when a write command is received for the first time after the power is turned on among write commands with respect to the one or more areas.

3. The magnetic disk device of claim 1, wherein the determining module is configured to determine the order as an order of the receiving time when the pre-scan control information comprises the receiving time.

4. The magnetic disk device of claim 1, wherein the determining module is configured to determine the order as a descending order of the number of receiving times when the pre-scan control information comprises the number of receiving times.

5. The magnetic disk device of claim 1, wherein the pre-scan control information is further configured to indicate a completed address that is an address of an area where the pre-scan is completed, the magnetic disk device further comprising:
an updating module configured to update the completed address in the pre-scan control information with an address of the area where the pre-scan is completed;
a controller configured to control writing of data to a predetermined area where the write command instructs to write the data, upon receipt of the write command; and
an identifying module configured to identify an area comprising the predetermined area where the write command instructs to write the data, and to determine whether the pre-scanning is completed on the predetermined area referring to the completed address indicated by the pre-scan control information for the identified area, wherein
the prescanner is configured to verify an area where it is determined that the pre-scanning is not completed after data writing is completed, and
the updating module is configured to update the completed address in the pre-scan control information with an address of an area where the prescanner has verified the completion of the pre-scanning.

6. The magnetic disk device of claim 5, wherein
the recording area comprises blocks,
each area and the predetermined area comprise one or more blocks, and
the prescanner is configured to verify on a first block preceding the area, a second block following the area, or the first and second blocks, after the data writing is completed.

7. The magnetic disk device of claim 5, wherein
the recording area comprises blocks,
each area and the predetermined area comprise one or more blocks,
the identifying module is configured to identify an area comprising a predetermined area where the read type command instructs to read data, when the receiver receives the read type command while the prescanner is pre-scanning, and to determine whether the pre-scan is completed on the predetermined area referring to the completed address indicated by the pre-scan control information for the identified area,
when the pre-scan is not completed, the controller is configured to control to read data from a block preceding the area and a block following the area as well as from the predetermined area, and
when the pre-scan is completed, the updating module is configured to update the completed address in the pre-scan control information with an address of an area where data reading is properly completed under control of the controller.
